(19) United States
(12) Patent Application Publication
(10) Pub. No.: US 2013/0137862 A1
(43) Pub. Date: May 30, 2013

(54) CELLULOSE CROSSLINKED FIBERS MANUFACTURED FROM PLASMA TREATED PULP

(71) Applicant: WEYERHAEUSER NR COMPANY, Federal Way, WA (US)

(72) Inventors: Angel Stoyanov, Federal Way, WA (US); Charles E. Miller, Federal Way, WA (US)

(73) Assignee: WEYERHAEUSER NR COMPANY, Federal Way, WA (US)

(21) Appl. No.: 13/733,622

(22) Filed: Jan. 3, 2013

Related U.S. Application Data
(63) Continuation-in-part of application No. 12/827,007, filed on Jun. 30, 2010, now abandoned.

(51) Int. Cl. C08B 15/10

(52) U.S. Cl. CPC C08B 15/10
USPC 536/56

(57) ABSTRACT

Intrafiber crosslinked cellulose pulp fibers manufactured from a plasma-treated pulp sheet are provided. The provided fibers have lower knot content and increased wet bulk compared to an untreated pulp sheet. Methods for forming the fibers are also provided.

### CROSS-REFERENCE TO RELATED APPLICATION

This application is a continuation-in-part of U.S. application Ser. No. 12/827,007, filed Jun. 30, 2010, the disclosure of which is hereby incorporated by reference in its entirety.

### DETAILED DESCRIPTION

Crosslinked fibers are conventionally produced by wetting dried conventional pulp fibers with a solution containing a crosslinking agent. The pulp fibers are in sheet or extended sheet form and are usually in a roll. The wetted pulp sheet is hammermilled to individualize the pulp fibers contained in the pulp sheet. The hammermilled pulp containing a crosslinking agent is then run through a flash drier to dry the fibers and start the crosslinking reaction and further heated in an oven to complete the crosslinking process. The crosslinking is intrafiber crosslinking in which the cellulose molecules within a cellulose fiber are crosslinked. Intrafiber crosslinking imparts twist and curl, as well as bulk, to the cellulose fiber.

At the start of the crosslinking process, the sheet of cellulose fibers is transported through the fiber treatment zone by a conveying device, for example, a conveyor belt or a series of driven rollers.

At the fiber treatment zone, a crosslinking agent formulation is applied to the sheet of cellulose fibers. The crosslinking agent formulation is preferably applied to one or both surfaces of the sheet using any one of a variety of methods, including spraying, rolling, or dipping. Once the crosslinking agent formulation has been applied to the sheet, the solution may be uniformly distributed through the sheet by, for example, passing the sheet through a pair of rollers.

After the sheet of fibers has been treated with the crosslinking agent, the wet sheet impregnated with crosslinking agent is fiberized by feeding the sheet through a hammermill. The hammermill serves to disintegrate the sheet into its component individual cellulose fibers, which are then air conveyed through a drying unit to remove the residual moisture.

The resulting treated pulp is then air conveyed through an additional heating zone (e.g., a dryer) to bring the temperature of the pulp to the cure temperature. In one embodiment, the dryer comprises a first drying zone for receiving the fibers and for removing residual moisture from the fibers via a flash-drying method, and a second heating zone for curing the crosslinking agent. Alternatively, in another embodiment, the treated fibers are blown through a flash-dryer to remove residual moisture, heated to a curing temperature, and then transferred to an oven where the treated fibers are subsequently cured. Overall, the treated fibers are dried and then cured for a sufficient time and at a sufficient temperature to achieve crosslinking. Typically, the fibers are oven-dried and cured for about 1 to about 20 minutes at a temperature from about 120° C. to about 200° C.

Representative processes for producing crosslinked cellulose fibers are disclosed in U.S. Pat. Nos. 7,147,446 and 7,399,377, both of which are incorporated herein by reference in their entirety.

The crosslinked fibers have unique combinations of stiffness and resiliency, which allow absorbent structures made from the fibers to maintain high levels of absorptivity, and exhibit high levels of resiliency and an expansionary responsiveness to wetting of a dry, compressed absorbent structure.

Cellulosic fibers useful for making the crosslinked cellulosic fibers are derived primarily from wood pulp. Suitable wood pulp fibers for use with the invention can be obtained from well-known chemical processes such as the kraft and sulfite processes, with or without subsequent bleaching. The pulp fibers may also be processed by thermomechanical (TMP), chemithermomechanical (CTMP) methods, or combinations thereof. The pulp fibers can be produced by chemical methods. Ground wood fibers, recycled or secondary wood pulp fibers, bleached and unbleached wood pulp fibers can be used, as well. One starting material is prepared from long-fiber coniferous wood species, such as southern pine, Douglas fir, spruce, and hemlock. Hardwood fibers such as aspen, birch or eucalyptus can also be used. Details of the production of wood pulp fibers are well-known to those skilled in the art. Suitable fibers are commercially available from a number of companies, including the Weyerhaeuser NR Company. For example, suitable cellulose fibers produced from southern pine that are usable in making the present invention are available from the Weyerhaeuser NR Company under the designations CF416, CF405, NF405, NB416, FR416, FR516, PW416 and PW405.

The crosslinking agent is applied to the cellulosic fibers in an amount sufficient to effect intrafiber crosslinking. The amount applied to the cellulosic fibers can be from about 1 to about 10 percent by weight based on the total weight of fibers.

Any one of a number of crosslinking agents and catalysts, if necessary, can be used to produce crosslinked fibers. The following are representative crosslinking agents and catalysts.

Suitable urea-based crosslinking agents include substituted ureas such as methylolated ureas, e.g., dimethylol urea (DMU, bis-[N-hydroxymethyl]urea), methylolated cyclic ureas, methylolated lower alkyl cyclic ureas, methylolated dihydroxy cyclic ureas, dihydroxy cyclic ureas, and lower alkyl substituted cyclic ureas. Specific cyclic urea-based crosslinking agents include dimethylol dihydroxy ethylene urea (DMDHEU, 1,3-dihydroxymethyl-4,5-dihydroxy-2-imidazolidinone), dihydroxy ethylene urea (DHEU, 4,5-dihydroxy-2-imidazolidinone), dimethylol ethylene urea (DMEU, 1,3-dihydroxymethyl-2-imidazolidinone), and dimethyl dihydroxy ethylene urea (DMeDHEU or DDI, 4,5-dihydroxy-1,3-dimethyl-2-imidazolidinone).

Suitable dialdehyde crosslinking agents include C₂-C₈ dialdehydes (e.g., glyoxal), C₂-C₈ dialdehyde acid analogs having at least one aldehyde group, and oligomers of these dialdehydes and dialdehyde acid analogs. Particular crosslinking agents within this group are glutaraldehyde, glyoxal, glyoxylic acid. Other crosslinking agents are acetals such as 2,3-dihydroxy-1,1,4,4-tetramethoxybutane, 3,4-dihydroxy-2,5-dimethoxytetrahydrofuran, glyceraldehydes dimethylacetal and C₂-C₈ monoaldehydes having an acid functionality.

Other suitable crosslinking agents are dichloro acetic acid, dichloro propanol-2, diepoxides, such as butadiene diepoxides, polyepoxides, N-methylol acrylamide, and divinylsulfone, condensation products of formaldehyde with organic compounds, such as urea, thiourea, guanidine, or melamine or other chemical compounds which contain at least two active hydrogen atoms, such as imidazolidine derivatives; dicarboxylic acids; diisocyanates; divinyl compounds; diepoxides; dihalogen-containing compounds such as dichloracetone and 1,3-dichloropropanol-2; and halohydrins such as epichlorohydrin, tetraoxan, and tetrakis (hydroxymethyl)phosphonium chloride. These can be used with alkaline catalysts, such as sodium hydroxide.

When working with certain polymers such as urea-formaldehyde and melamine-formaldehyde, a mineral acid, such as sulfuric acid, may be added with the polymeric compound. The acid may be added in an amount sufficient to adjust the pH of the aqueous fiber slurry to from about 3.0 to about 5.5. It is believed that the acid acts as a catalyst to accelerate the reaction of the polymeric compound during the drying step.

Other suitable crosslinking agents include carboxylic acid crosslinking agents such as C₂-C₈ monomeric polycarboxylic acids that contain at least three carboxyl groups (e.g., citric acid, propane tricarboxylic acid (tricarballylic acid), butane tetracarboxylic acid (BTCA) and oxydisuccinic acid). Specific suitable polycarboxylic acid crosslinking agents include tartrate monosuccinic acid and/or tartrate disuccinic acid; dicarboxylic acids like tartaric acid, malic acid, succinic acid, glutaric acid, citraconic acid, itaconic acid, maleic acid; polymeric polycarboxylic acids like polyacrylic acid, polymethacrylic acid, polymaleic acid; polymethylvinylether-co-maleate copolymer, polymethylvinylether-co-itaconate copolymer, copolymers of acrylic acid, and copolymers of maleic acid; polyacrylic acids, having phosphorous incorporated into the polymer chain (as a phosphinate) by introduction of sodium hypophosphite during the polymerization process.

Suitable catalysts for the above mentioned urea-based methylolated crosslinking agents can include acidic salts, such as ammonium chloride, ammonium sulfate, aluminum chloride, magnesium chloride, magnesium nitrate. Different alums, including aluminum sulfate, are suitable catalysts for the above mentioned aldehyde crosslinking agents. Alkali metal salts of phosphorous-containing acids, like phosphoric, polyphosphoric, phosphorous and hypophosphorous acids are suitable for the polycarboxylic acids crosslinking agents. The amount of catalyst, if required, can vary. Mixtures or blends of crosslinking agents and catalysts can also be used.

Cellulosic fibers may be treated with a debonding agent prior to treatment with the crosslinking agent. Debonding agents tend to minimize interfiber hydrogen bonds and allow the fibers to separate from each other more easily. However, debonding agents reduce the strength of the chemically treated pulp sheet before hammermilling which can cause web breakage, especially at higher production rates. The debonding agent may be cationic, nonionic or anionic. Cationic debonding agents appear to be superior to nonionic or anionic debonding agents. The debonding agent typically is added to cellulose fiber stock.

Suitable cationic debonding agents include quaternary ammonium salts. These salts typically have one or two lower alkyl substituents and one or two substituents that are or contain fatty, relatively long-chain hydrocarbon. Nonionic debonding agents typically comprise reaction products of fatty-aliphatic alcohols, fatty-alkyl phenols and fatty-aromatic and aliphatic acids that are reacted with ethylene oxide, propylene oxide, or mixtures of these two materials.

A suitable debonding agent is, for example, Berocell 584 from Berol Chemicals, Incorporated of Metairie, La. It may be used at a level of 0.25% weight of debonder to weight of fiber.

Knots are unfiberized fiber clumps or pieces of the original pulp sheet. Crosslinked pulp can have a knot content that is greater than 25%. Knots can be detected by placing a small portion of pulp into a clear beaker of water and stirring the water to mix the fibers. Most of the fiber will mix into the water as single fibers; however, fiber clumps will be readily visible. The fiber clumps or knots are undesirable by-products of the hammermilling process. As production speeds increase, the level of knots increases as the hammermilling efficiency is reduced. Thus there is a need for increasing production speeds without increasing knots and without the sheet breaks associated with debonded pulp (as noted above).

The amount of knots in a pulp that has been hammermilled can be quantified by using a screening system with acoustical energy used as the means to classify the fiber into amounts of knots, accepts and fines. It is desirable to have low knots and fines and high accepts, where the accepts are the singulated fibers. It is desirable to have a lower amount of knots in crosslinked pulp.

As used herein, the term “sonic knots” (also known as “2×sonic knots”) refers to the knot content of fibers. The following (“sonic fractionation”) method may test for the presence of sonic knots by classifying dry crosslinked fluffed pulp into four layered fractions based on screen mesh size. The first fraction is the layer knots and is defined as that material that is captured by a No. 5 mesh screen. The second fraction is composed of the intermediate knots and is defined as the material captured by a No. 8 mesh screen. The third fraction consists of smaller knots and is defined as the material captured by a No. 12 mesh screen. The fourth fraction consists of accepts or the singulated fibers and is defined as that material that passes through No. 5, 8, and 12 mesh screens but is captured by a No. 60 mesh screen. The separation is accomplished by sound waves generated by a speaker that are imposed upon a pre-weighed sample of fluff pulp placed on the first layered No. 5 mesh screen that is near the top of a separation column where the speaker sits at the very top. After a set period of time, each fraction from the No. 5, 8 and 12 screens is removed from the separation column and is added back to the No. 5 screen for the second pass through the sonic test. After the set period of time, each fraction from the No. 5, 8 and 12 screens is removed from the separation column and weighed to obtain the weight fraction of knots, accepts/singulated fiber and fines.

As noted above, knots are an unwanted result of forming crosslinked fibers. Knots essentially represent an inefficiency in the product because they concentrate fiber mass and, thereby, disrupt uniform distribution of materials throughout the formed product. Because knots are undesirable, efforts have been made to reduce or eliminate knots in crosslinked fibers. Attempts to reduce knots include using process or chemistry modifications.

The wet bulk of a fiber is typically maximized during production. Similar to attempts to reduce knots, chemistry has been used in an attempt to improve wet bulk performance.

However, until now, to the best of the inventors' knowledge, there has never been an established link between the knot content and wet bulk of crosslinked fibers.

Typically, knots and wet bulk are investigated separately and any link between the two has not previously been considered. Similarly, there is no evidence in the prior art that both wet bulk increase and knot content decrease can be improved at the same time and/or by the same process. The inventors have discovered a treatment for pulp that reduces the knot content of crosslinked cellulose pulp fibers that is especially applicable at higher production rates. This is unexpected because the same treatment either does not affect, or slightly increases, the knot content of treated cellulose pulp fibers that have not been crosslinked.

The discovered treatment is a plasma pre-treatment of the pulp (e.g., in sheet form) before the application of the crosslinking formulation. The crosslinking formulation includes a crosslinking agent and a catalyst, if desired. Corona treatment of fibers has been found to improve wettability and make fibers more bondable. However, corona treatment of fibers has not been combined with other pre-treatment processes, such as crosslinking. In one embodiment of a method in accordance with this disclosure, the pulp is pre-treated with plasma prior to delivery to a crosslinking facility. Additionally, in another embodiment, the pulp is plasma pre-treated off-line prior to crosslinking in a crosslinking facility.

Plasma can be defined as a substance wherein many of the atoms or molecules are effectively ionized, allowing charges to flow freely. This collection of charged particles containing about equal numbers of positive ions and electrons exhibits some properties of a gas, but differs from a gas in being a good conductor of electricity and in being affected by a magnetic field. Some scientists have dubbed plasma the “fourth state of matter” because while plasma is neither gas nor liquid, its properties are similar to those of both gases and liquids.

With the addition of heat or other energy, a significant number of atoms release some or all of their electrons. This leaves the remaining parts of those atoms with a positive charge, and the detached negative electrons are free to move about. These atoms and the resulting electrically charged gas are said to be “ionized.” When enough atoms are ionized to a point that significantly affects the electrical characteristics of the gas, it is a plasma. Plasmas can carry electrical currents and generate magnetic fields. A common method for producing a plasma is by applying an electric field to a gas in order to accelerate the free electrons.

Processes like corona treatment, gas atmosphere plasma, flame plasma, atmospheric plasma, low pressure plasma, vacuum plasma, glow-discharge plasma all rely on the properties of plasma.

Common forms of atmospheric pressure plasma treatments are described below.

### Corona Discharge (CD) Treatment:

Corona discharge (also referred to as “corona treatment”) is at the simple end of the plasma scale, and is a lower cost alternative. Corona discharge is characterized by bright filaments extending from a sharp, high-voltage electrode towards the substrate. Corona treatment is one of the most established and most widely used plasma process; it has the advantage of operating at atmospheric pressure, the reagent gas usually being the ambient air.

In corona treatment the pulp sheet travels between a high voltage electrode and a ground electrode. The high voltage electrode (with highly asymmetric geometry, examples being sharply pointed needle or thin wire electrodes opposing flat planes of large diameter cylinders) faces one side of the pulp sheet and the ground electrode faces the opposite side of the pulp sheet. Typically, there is a dielectric covering the ground electrode (which is typically a roll). In some corona discharge stations, the dielectric covers the high voltage electrode instead of the ground electrode. In another embodiment, both sides of the pulp sheet are treated.

The electrodes are powered with high, continuous or pulsed DC or AC voltages. The high electric field around the point of the needle or the wire causes electrical breakdown and ionization of whatever gas surrounds the needle (wire) and plasma is created, which is discharged in a fountain-like spray out from the point or wire. Plasma types are characterized by the number, density and temperature of the free electrons in the system. Coronas are very weakly ionized with a free electron density of about 10⁸ electrons/cm³. The corona is strongly non-thermal with very high energy free electrons with temperatures in excess of 100000 K.

A high frequency generator and a high voltage output transformer is attached to the high voltage electrode. This raises the incoming electricity from, typically, a frequency of 50 to 60 Hz and a voltage of 230 V to a frequency of 10 to 35 kHz and a voltage of 10 kV. The power source is rated in watts or kilowatts.

Dielectric Barrier Discharge (Silent Discharge):

The dielectric barrier discharge is a broad class of plasma sources that has an insulating (dielectric) cover over one or both of the electrodes and operates with high voltage (1-20 kV) power running at frequencies of 1 to 100 kHz. This results in a non-thermal plasma and a multitude of random, numerous arcs formed between electrodes, (which in contrast to the corona system, have symmetrical geometry—two parallel conducting plates) placed in opposition to each other. The DBD plasma is large area, non-thermal and more uniform than the CD. Because of charge accumulation on the dielectric, which tends to neutralize the applied electric field thus choking off the plasma, the DBD must be powered by AC. This kind of plasma is denser than the corona with a typical free electron density of about 10¹⁰ electrons/cm³ but the free electrons are slightly cooler at temperatures of 20000 to 50000 K.

Atmospheric Pressure Glow Discharges (APGD):

Glow discharge is characterized as a uniform, homogeneous and stable discharge usually generated in helium or argon (and some in nitrogen). The APGD is generated by application of relatively low (˜200 V) voltages across symmetrical planar or curved electrodes, at high frequency, or even very high frequency, radio frequencies 2-60 MHz, much higher than the other plasma types. The electrodes are not covered by dielectric, but are bare metal, which enables significantly higher power densities (up to 500 W/cm³). The APGD is denser than the DBD, with typical free electron densities of 10¹¹-10¹² electrons/cm³, but the free electrons are slightly cooler at temperatures 10000 to 20000 K.

Other than ambient air, gases, such as but not limited to, helium, argon, nitrogen, hydrogen and oxygen may be used to generate plasma.

Representative plasma treatments that can be used on the pulp sheet include corona discharge, dielectric barrier discharge, atmospheric pressure glow discharge, and diffuse coplanar surface barrier discharge. In one embodiment the plasma pre-treatment of the pulp sheet will provide a crosslinked pulp fiber product having knot content that is less than 25% based on the sonic fractionation test. In another embodiment the plasma pre-treatment of the pulp sheet will provide a crosslinked pulp fiber product having knot content that is less than 20% based on the sonic fractionation test. In another embodiment the plasma pre-treatment of the pulp sheet will provide a crosslinked pulp fiber product having knot content that is less than 15% based on the sonic fractionation test.

In an exemplary test, the impact of corona treatment on non-crosslinked fiber was determined. In the test, a pulp sheet is composed of cellulose wood pulp fibers that have been dried to a water content of less than 10%. The pulp fibers are hydrogen bonded together. The pulp sheet has a basis weight of 500 to 1200 g/m² and is typically available in roll or bale form. Several rolls of pulp were corona treated (“Treated” in Table 1) and tested for sonic knots. The pulp was CF416, a southern pine kraft pulp without debonder available from Weyerhaeuser NR Company. The corona treatment level was 10 watt density. Watt density (also referred to herein as “power density”) is a measurement of the amount of energy being applied to the pulp sheet. It is measured in watts/ft²/minute. Watt density takes into account the amount of power being applied (watts), the time it is being applied (minutes) and the amount of material it is being applied to (ft²). The sonic knots test was as described above. The results are disclosed in Table 1, which indicates that knots tend to increase when the pulp sheet is corona treated.

TABLE 1
Corona-treated, non-crosslinked fibers.

| | Roll 1 | | Roll 2 | | Roll 3 | |
|---|---|---|---|---|---|---|
| | Control | Treated | Control | Treated | Control | Treated |
| Sonic knots, % | 8 | 11 | 8 | 10 | 10 | 11 |

In a second exemplary test, rolls of southern pine softwood kraft pulp (CF416) were corona treated at three different levels, and crosslinked with polyacrylic acid. The samples were tested for sonic knots. The results are disclosed in Table 2.

TABLE 2
Corona-treated, crosslinked fibers.

| | Control | Sample 1 | Sample 2 | Sample 3 |
|---|---|---|---|---|
| Corona Watt density, | — | 8 | 10 | 15+ |
| Watts/ft²/min | | | | |
| Sonic knots, % | 24.3 | 21.2 | 17.0 | 13.9 |
| Improvement, % | — | 12.8 | 30 | 42.7 |

As illustrated above, the crosslinked material (Table 2) had marked improvement in knots when corona treated. This was not the case with non-crosslinked pulp, in which sonic knots tended to increase after corona treatment (Table 1).

Corona treatment also enables faster production of fiber. Briefly, the pulp sheet is first fed into a chemical vat where the crosslinking agent is applied. This chemically impregnated pulp sheet is then fiberized in a hammermill. As production rates increase (e.g., the speed of the pulp sheet feed is increased), there is less time for the crosslinking formulation to penetrate the sheet before hammermilling. This is known to cause an increase in knots or unfiberized pieces of the pulp sheet. Hammermill efficiency and performance is maintained even at faster rate. As set forth below, by treating the pulp sheet with corona discharge prior to the crosslinking process, faster production rates are enabled.

Without being limited to theory, the inventors believe that pre-treatment with plasma disrupts the hydrogen bonding of the pulp sheet surfaces and improves the absorbency of the pulp sheet surface, thereby improving or enhancing the penetration or impregnation of the crosslinking formulation into the pulp sheet. Thus, plasma treated pulp sheets remove this limitation allowing faster production. In one embodiment, the pulp sheet is pre-treated with plasma, such as corona discharge, then treated with crosslinking agent, then hammermilled or otherwise defiberized, then heat treated to first dry the sheet and then to facilitate the crosslinking reaction.

If the plasma treatment is corona discharge treatment, the corona treatment can be from 5 to 15 Watts/ft²/min, or greater.

In an exemplary test, the effect of an increase in production rate was tested with regard to the impact on fiber knots and wet bulk. As illustrated in Table 3, increasing the production rate 20% resulted in increased knot content and decreased wet bulk.

TABLE 3
Production rate trial: knots and wet bulk.

| | DE | Wet Bulk, |
|---|---|---|
| | Knots* | 0.6 kPa |
| Sample | % | cm³/g |
| Traditional production rate, 30.5 m/min sheet feed | 37.1 | 16.3/16.2 |
| 20% production increase (36.6 m/min sheet feed) | 46.8 | 15.1/14.9 |

*Note: Defibration Efficiency (DE) Tester is available from Courtray Consulting Labservice, 2 Charles MONSARRAT, 59500 Douai, France.
Sample size: 9 grams, Cycle conditions: one 6 minute cycle using 16 mesh screen (1.18 mm hole size) at 35 psi.

The fiber absorption quality analyzer (“FAQ”; Weyerhaeuser Co., Federal Way Wash.) is used to determine the fiber bulk (wet and dry), absorbent capacity, and wet resilience of pulp fibers. In the procedure, a 4-gram sample of the pulp fibers is put through a pinmill to open the pulp and then air-laid into a tube. The tube is then placed on the FAQ Analyzer. A plunger then descends on the fluff pad at a pressure of 0.6 kPa and the pad height bulk is determined. The weight is increased to achieve a pressure of 2.5 kPa and the bulk recalculated. The result is two bulk measurements on the dry pulp under two different pressures. While under the 2.5 kPa pressure, water is introduced into the bottom of the tube (bottom of the pad). The time required for the water to reach the plunger is measured. From this the absorption time and absorption rate are determined. The final bulk of the wet pad at 2.5 kPa is also measured. The plunger is then withdrawn from the tube and the wet pad allowed to expand for 60 seconds. The plunger is reapplied at 0.6 kPa and the wet bulk determined. The final bulk of the wet pad at 0.6 kPa is considered the wet bulk (cm³/g) of the pulp. The capacity is determined by weighing the wet pad after the water is drained from the equipment, and reported as grams water per gram dry fiber.

Keeping in mind that it is desirable to minimize knots and maximize wet bulk of manufactured fiber, it is apparent from the Table 3 data that increasing the production rate produces an inferior product, with respect to knot content. However, increasing production rate would be very desirable if the fiber quality produced at a traditional production rate could be maintained.

Corona treatment of pulp was explored in greater depth as a potential means for speeding production rate without compromising hammermill performance, as measured by knot level and fiber wet bulk. As illustrated in Table 4, the watt density used in the corona treatment impacts both the knot content and wet bulk properties. As corona power increases, knots decrease and wet bulk increases, both of which are favorable results from a fiber-quality perspective.

TABLE 4
Corona power variation at constant production rate (30.5 m/min sheet feed).

| | Corona Treatment | Sonic Knots, | Wet Bulk, |
|---|---|---|---|
| Sample | Level, Watt Density | % | 0.6 kPa cm³/g |
| Control | 0 | 24.3 | 17.6 |
| Corona 1 | 8 | 21.2 | 18.0 |
| Corona 2 | 10 | 17.0 | 18.2 |
| Corona 3 | 15 | 13.9 | 18.3 |

With the favorable results achieved in the experiments yielding the Table 4 data, corona treatment was then tested as a means for increasing production rate in a commercial trial. As illustrated in Table 5, increasing production rate had no negative effect, and actually had a positive effect, on the knot content and wet bulk of the formed fiber.

TABLE 5
Corona treatment (10 Watt Density) with varied production rate.

| | Sonic Knots, | Wet Bulk, |
|---|---|---|
| Sample | % | 0.6 kPa cm³/g |
| Commercial rate | 21.5 | 17.9 |
| 30.5 m/min sheet feed | | |
| 8% increased rate | 16.0 | 19.0 |
| 33.0 m/min sheet feed | | |
| 17% increased rate | 16.5 | 18.4 |
| 35.7 m/min sheet feed | | |

In view of the disclosed embodiments, corona treatment can be used as a means for increasing the production rate of fiber while maintaining or controlling the knot content and wet bulk properties when compared to a traditional commercial production rate. In certain embodiments, corona treatment was found to decrease the knot content when the production rate is increased. In certain embodiments, corona treatment increased the wet bulk when the production rate was increased. And in certain embodiments, the knot content decreased and the wet bulk increased when the production rate was increased.

As illustrated previously, corona treatment can be used in conjunction with crosslinking to produce a superior fiber product. Therefore, corona treated crosslinked fiber is particularly amenable to being formed using increased production rates while maintaining (or improving) knot level and wet bulk properties.

In one aspect, individual intrafiber-crosslinked fibers made from cellulose wood pulp, the crosslinked fibers having less than 20% knot content, as measured by the sonic knot test, and a wet bulk greater than 18 cm³/g, as measured by the fiber absorption quality test. In one embodiment, the cellulose wood pulp is pre-treated with plasma prior to forming the crosslinked fibers. In one embodiment, the crosslinked fibers have a knot content of less than 15%. In one embodiment, the wet bulk is at least 19 cm³/g.

In another aspect, a method of forming individual intrafiber-crosslinked fibers is provided. In one embodiment, the method includes: treating a cellulose wood pulp with a plasma treatment to provide plasma-treated pulp; applying a crosslinking-agent to the plasma-treated pulp while moving the plasma-treated pulp at a feed rate greater than 30.5 m/min; fiberizing the plasma-treated pulp; and crosslinking the plasma-treated pulp to provide individual intrafiber-crosslinked fibers.

In one embodiment, the feed rate is 33.0 m/min or greater. In one embodiment, the feed rate is 35.7 m/min or greater.

In one embodiment, the plasma treatment has a power density of 8 watts/ft²/min or greater. In one embodiment, the plasma treatment has a power density of 10 watts/ft²/min or greater. In one embodiment, the plasma treatment has a power density of 15 watts/ft²/min or greater.

In another aspect, individual intrafiber-crosslinked fibers made from cellulose wood pulp according to the method of the previous aspect are provided. In one embodiment, the individual intrafiber-crosslinked fibers have less than 20% knot content, as measured by the sonic knot test, and a wet bulk greater than 18 cm³/g, as measured by the fiber absorption quality test. In one embodiment, the crosslinked fibers have a knot content less than 15%. In one embodiment, the wet bulk is at least 19 cm³/g.

While illustrative embodiments have been illustrated and described, it will be appreciated that various changes can be made therein without departing from the spirit and scope of the invention.

The embodiments of the invention in which an exclusive property or privilege is claimed are defined as follows:

1. Individual intrafiber-crosslinked fibers made from cellulose wood pulp, the crosslinked fibers having less than 20% knot content, as measured by a sonic knot test, and a wet bulk greater than 18 cm³/g, as measured by a fiber absorption quality test.

2. The individual intrafiber-crosslinked fibers of claim 1, wherein the cellulose wood pulp is pre-treated with plasma prior to forming the crosslinked fibers.

3. The individual intrafiber-crosslinked fibers of claim 1, wherein the crosslinked fibers have a knot content of less than 15%.

4. The individual intrafiber-crosslinked fibers of claim 1, wherein the wet bulk is at least 19 cm³/g.

5. A method of forming individual intrafiber-crosslinked fibers, comprising:
treating a cellulose wood pulp with a plasma treatment to provide plasma-treated pulp;
applying a crosslinking-agent to the plasma-treated pulp while moving the plasma-treated pulp at a feed rate greater than 30.5 m/min;
fiberizing the plasma-treated pulp; and
crosslinking the plasma-treated pulp to provide individual intrafiber-crosslinked fibers.

6. The method of claim 5, wherein the feed rate is 33.0 m/min or greater.

7. The method of claim 5, wherein the feed rate is 35.7 m/min or greater.

8. The method of claim 5, wherein fiberizing the plasma-treated pulp comprises hammermilling the plasma-treated pulp.

9. The method of claim 5, wherein the cellulose wood pulp is a pulp sheet.

10. The method of claim 5, wherein the plasma treatment is a corona discharge treatment.

11. The method of claim 5, wherein the plasma treatment has a power density of 8 watts/ft²/min or greater.

12. The method of claim 5, wherein the plasma treatment has a power density of 10 watts/ft²/min or greater.

13. The method of claim 5, wherein the plasma treatment has a power density of 15 watts/ft²/min or greater.

14. Individual intrafiber-crosslinked fibers made from cellulose wood pulp according to the method of claim 5, the individual intrafiber-crosslinked fibers having less than 20% knot content, as measured by a sonic knot test, and a wet bulk greater than 18 cm³/g, as measured by a fiber absorption quality test.

15. The individual intrafiber-crosslinked fibers of claim 14, wherein the crosslinked fibers have a knot content less than 15%.

16. The individual intrafiber-crosslinked fibers of claim 14, wherein the wet bulk is at least 19 cm³/g.
